(19) United States
(12) Patent Application Publication
(10) Pub. No.: US 2024/0069542 A1
(43) Pub. Date: Feb. 29, 2024

(54) VEHICLE REMOTE GUIDANCE SYSTEM

(71) Applicant: FORD GLOBAL TECHNOLOGIES, LLC, Dearborn, MI (US)

(72) Inventor: Arek SREDZKI, Vancouver (CA)

(21) Appl. No.: 18/455,036

(22) Filed: Aug. 24, 2023

Related U.S. Application Data
(60) Provisional application No. 63/402,501, filed on Aug. 31, 2022.

(51) Int. Cl. G05D 1/00; B60W 60/00

(52) U.S. Cl. CPC G05D 1/0022; B60W 60/001; B60W 2556/45

(57) ABSTRACT

A vehicle includes a sensor configured to provide sensor data indicative of an environment outside the vehicle; one or more transceivers configured to communicate with a server; and one or more controllers configured to, responsive to the sensor data indicative of a predefined trigger event, send a request for remote guidance to the server via the transceiver, receive an instruction including a plurality of waypoints from the server, determine a first section of a trajectory along a route defined by the waypoints, and perform a driving maneuver to implement the trajectory.

### CROSS-REFERENCE TO RELATED APPLICATIONS

This application claims the benefit of U.S. provisional application Ser. No. 63/402,501 filed on Aug. 31, 2022, the disclosure of which is hereby incorporated in its entirety by reference herein.

### TECHNICAL FIELD

The present disclosure generally relates to a system for operating a vehicle. More specifically, the present disclosure relates to a remote guidance (RG) system for an autonomous vehicle.

### BACKGROUND

Some modern vehicles are provided with autonomous driving features which allows the vehicle to be operated autonomously with minimal driver inputs. The autonomous driving features rely on vehicle sensors measuring the driving condition. A controller or processor may be used to process the sensor data indicative of the driving condition to make decisions on how to operate the vehicle. In some situations, the sensor data may reflect a situation that is not the controller is not ready to process. For instance, if an obstacle is detected (e.g. construction zone) and the vehicle needs to drive onto the oncoming traffic lanes to overcome the obstacle, more sophisticated verifications may be required before the controller is allowed to make such a maneuver.

### SUMMARY

In one or more illustrative examples of the present disclosure, a vehicle includes a sensor configured to provide sensor data indicative of an environment outside the vehicle; one or more transceivers configured to communicate with a server; and one or more controllers configured to, responsive to the sensor data indicative of a predefined trigger event, send a request for remote guidance to the server via the transceiver, receive an instruction including a plurality of waypoints from the server, determine a first section of a trajectory along a route defined by the waypoints, and perform a driving maneuver to implement the trajectory.

In one or more illustrative examples of the present disclosure, a method for a vehicle includes requesting remote guidance in response to detecting a predefined trigger event via a sensor; receiving an instruction including a first section of a trajectory along a route defined by a plurality of waypoints; and performing a driving maneuver to traverse the first section of trajectory.

In one or more illustrative examples of the present disclosure, a non-transitory computer-readable medium includes instructions, when executed by a controller of a vehicle, cause the vehicle to perform operations including: responsive to receiving a first instruction including a plurality of waypoints from a server, determine a first trajectory using the waypoints, and perform a driving maneuver to implement the first trajectory.

### BRIEF DESCRIPTION OF THE DRAWINGS

For a better understanding of the invention and to show how it may be performed, embodiments thereof will now be described, by way of non-limiting example only, with reference to the accompanying drawings, in which:

FIG. 1 is an example block topology of a vehicle system of one embodiment of the present disclosure.

FIG. 2 is a front-perspective view of an exemplary vehicle with an autonomous driving feature of one embodiment of the present disclosure.

FIG. 3 is an example flow diagram of a process for remote guidance of a vehicle of one embodiment of the present disclosure.

FIGS. 4A and 4B are a schematic diagram of the vehicle remote guidance of one embodiment of the present disclosure.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure, among other things proposes a system for operating an autonomous vehicle. More specifically, the present disclosure proposes a remote guidance system to assist the operation of an autonomous vehicle on a waypoint basis, i.e., along a route defined by waypoints. A waypoint refers to a point of reference that can be used for location and navigation. For example, a waypoint may represent the coordinates or specific latitude and longitude of a location. A route refers to a path that extends along a plurality of waypoints. A trajectory refers to a segment of the route.

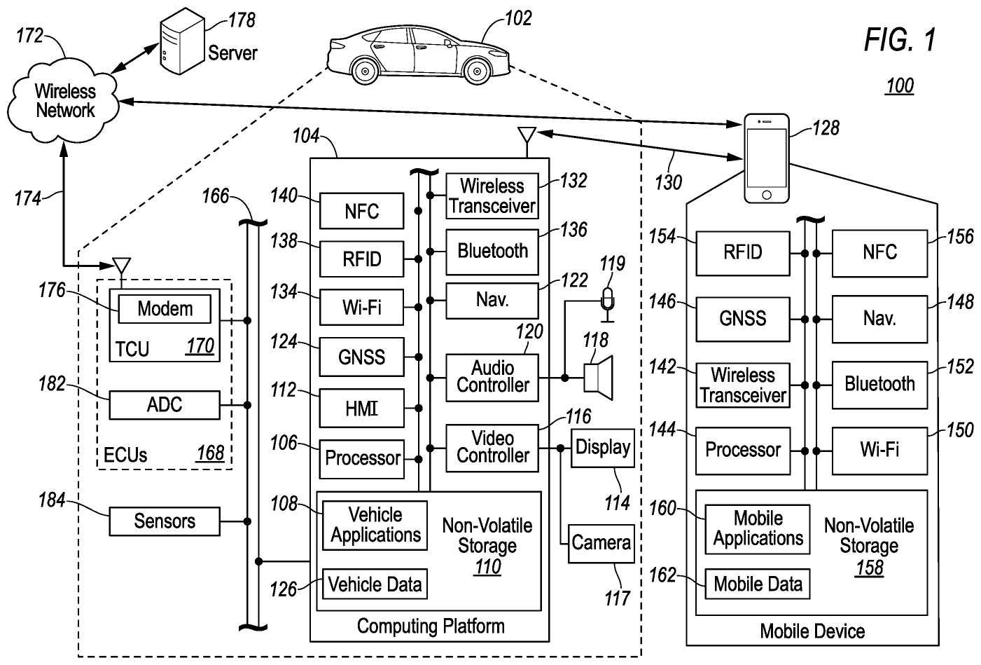

Referring to FIG. 1, an example block topology of a vehicle system 100 of one embodiment of the present disclosure is illustrated. A vehicle 102 may include various types of automobile, crossover utility vehicle (CUV), sport utility vehicle (SUV), truck, recreational vehicle (RV), boat, plane, or other mobile machine for transporting people or goods. In many cases, the vehicle 102 may be powered by an internal combustion engine. As another possibility, the vehicle 102 may be a battery electric vehicle (BEV), a hybrid electric vehicle (HEV) powered by both an internal combustion engine and one or move electric motors, such as a series hybrid electric vehicle (SHEV), a plug-in hybrid electric vehicle (PHEV), a parallel/series hybrid vehicle (PSHEV), or a fuel-cell electric vehicle (FCEV) or other mobile machine for transporting people or goods. It should be noted that the illustrated system 100 is merely an example, and more, fewer, and/or differently located elements may be used.

As illustrated in FIG. 1, a computing platform 104 may include one or more processors 106 configured to perform instructions, commands, and other routines in support of the processes described herein. For instance, the computing platform 104 may be configured to execute instructions of vehicle applications 108 to provide features such as navigation, remote controls, and wireless communications or the like. Such instructions and other data may be maintained in a non-volatile manner using a variety of types of computer-readable storage medium 110. The computer-readable medium 110 (also referred to as a processor-readable medium or storage) includes any non-transitory medium (e.g., tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and structured query language (SQL).

The computing platform 104 may be provided with various features allowing the vehicle occupants/users to interface with the computing platform 104. For example, the computing platform 104 may receive input from human machine interface (HMI) controls 112 configured to provide for occupant interaction with the vehicle 102. As an example, the computing platform 104 may interface with one or more buttons, switches, knobs, or other HMI controls configured to invoke functions on the computing platform 104 (e.g., steering wheel audio buttons, a push-to-talk button, instrument panel controls, etc.).

The computing platform 104 may also drive or otherwise communicate with one or more displays 114 configured to provide visual output to vehicle occupants by way of a video controller 116. In some cases, the display 114 may be a touch screen further configured to receive user touch input via the video controller 116, while in other cases the display 114 may be a display only, without touch input capabilities. the computing platform 104 may also drive or otherwise communicate with one or more cameras 117 configured to provide video input to the vehicle 102. The computing platform 104 may also drive or otherwise communicate with one or more speakers 118 configured to provide audio output to vehicle occupants by way of an audio controller 120. The computing platform 104 may also drive or otherwise communicate with one or more microphones 119 configured to provide audio input to the vehicle 102.

The computing platform 104 may also be provided with navigation and route planning features through a navigation controller 122 configured to calculate navigation routes responsive to user input via e.g., the HMI controls 112, and output planned routes and instructions via the speaker 118 and the display 114. Location data that is needed for navigation may be collected from a global navigation satellite system (GNSS) controller 124 configured to communicate with multiple satellites and calculate the location of the vehicle 102. The GNSS controller 124 may be configured to support various current and/or future global or regional location systems such as global positioning system (GPS), Galileo, Beidou, Global Navigation Satellite System (GLONASS) and the like. Map data used for route planning may be stored in the storage 110 as a part of the vehicle data 126. Navigation software may be stored in the storage 110 as one the vehicle applications 108.

The computing platform 104 may be configured to wirelessly communicate with a mobile device 128 of the vehicle users/occupants via a wireless connection 130. The mobile device 128 may be any of various types of portable computing devices, such as cellular phones, tablet computers, wearable devices, smart watches, smart fobs, laptop computers, portable music players, or other device capable of communication with the computing platform 104. A wireless transceiver 132 may be in communication with a Wi-Fi controller 134, a Bluetooth controller 136, a radio-frequency identification (RFID) controller 138, a near-field communication (NFC) controller 140, and other controllers such as an ultra-wideband (UWB) transceiver, a Zigbee transceiver, an IrDA transceiver, and configured to communicate with a compatible wireless transceiver 142 of the mobile device 128.

The mobile device 128 may be provided with a processor 144 configured to perform instructions, commands, and other routines in support of the processes such as navigation, telephone, wireless communication, and multi-media processing. For instance, the mobile device 128 may be provided with location and navigation functions via a GNSS controller 146 and a navigation controller 148. The mobile device 128 may be provided with a wireless transceiver 142 in communication with a Wi-Fi controller 150, a Bluetooth controller 152, a RFID controller 154, an NFC controller 156, and other controllers (not shown), configured to communicate with the wireless transceiver 132 of the computing platform 104. The mobile device 128 may be further provided with a non-volatile storage 158 to store various mobile application 160 and mobile data 162.

The computing platform 104 may be further configured to communicate with various components of the vehicle 102 via one or more in-vehicle network 166. The in-vehicle network 166 may include, but is not limited to, one or more of a controller area network (CAN), an Ethernet network, and a media-oriented system transport (MOST), as some examples. Furthermore, the in-vehicle network 166, or portions of the in-vehicle network 166, may be a wireless network accomplished via Bluetooth low-energy (BLE), Wi-Fi, UWB, or the like.

The computing platform 104 may be configured to communicate with various electronic control units (ECUs) 168 of the vehicle 102 configured to perform various operations. For instance, the computing platform 104 may be configured to communicate with a telematics control unit (TCU) 170 configured to control telecommunication between vehicle 102 and a wireless network 172 through a wireless connection 174 using a modem 176. The wireless connection 174 may be in the form of various communication network e.g., a cellular network. Through the wireless network 172, the vehicle 102 may access one or more servers 178 to access various content for various purposes. It is noted that the terms wireless network and server are used as general terms in the present disclosure and may include any computing network involving carriers, router, computers, controllers, circuitry or the like configured to store data and perform data processing functions and facilitate communication between various entities. The ECUs 168 may further include an autonomous driving controller (ADC) 182 configured to control autonomous driving features of the vehicle 102. The vehicle 102 may be further provided with one or more sensors configured to measure various data to facilitate the ADC 182 to perform the autonomous driving operations. As a few non-limiting examples, the sensors 184 may include one or more cameras configured to capture images from the vehicle. The sensors 184 may further include one or more ultra-sonic radar sensors and/or lidar sensors to detect object at the vicinity of the vehicle 102. The sensors 184 may be divided and grouped into one or more sensor assemblies located at different locations of the vehicle 102. In general, the ADC 182 may be configured to autonomously operate the vehicle based on sensor data without requiring inputs or instructions from the server 178. However, in certain situations when the sensor data is indicative of a situation that is difficult for the ADC 182 to make the decision, the vehicle 102 may request further assistance from the server 178 for remote guidance. For instance, responsive to detecting the planned vehicle lane is blocked (e.g. by construction) and overcoming the blockage requires the vehicle 102 to use a lane for oncoming traffic, the ADC 182 may request for remote guidance before proceeding with the maneuver.

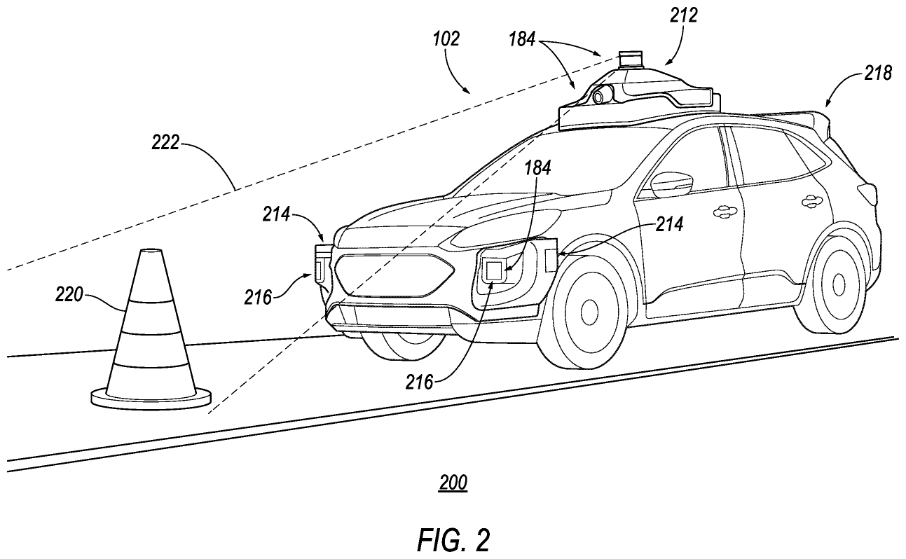

With reference to FIG. 2, a front-perspective view 200 of an exemplary vehicle 102 with an autonomous driving feature of one embodiment of the present disclosure is illustrated. With continuing reference to FIG. 1, the vehicle 102 may include a plurality of sensor assemblies incorporating various sensors 184 to collectively monitor a field-of-view (FoV) around the vehicle 102 in the near-field and the far-field. In the example illustrated with reference to FIG. 2, the vehicle 102 may include a top sensor assembly 212, two side sensor assemblies 214, two front sensor assemblies 216, and a rear sensor assembly 218, according to aspects of the disclosure. Each sensor assembly includes one or more sensors 184, such as a camera, a lidar sensor, and a radar sensor as discussed above with reference to FIG. 1.

The top sensor assembly 212 may be mounted to the top of the vehicle 102 and include multiple sensors 184, such as one or more lidar sensors and cameras. The lidar sensors may rotate about an axis to scan a 360-degree FoV about the vehicle 102. The side sensor assemblies 214 may be mounted to a side of the vehicle 102, for example, to a front fender as shown in FIG. 2, or within a side-view mirror. Each side sensor assembly 214 may include multiple sensors 184, such as, a lidar sensor and a camera to monitor a FoV adjacent to the vehicle 102 in the near-field. The front sensor assemblies 216 may be mounted to a front of the vehicle 102, such as, below the headlights or on the grill. Each front sensor assembly 216 may include multiple sensors 184, for example, a lidar sensor, a radar sensor, and a camera to monitor a FoV in front of the vehicle 102 in the far-field. The rear sensor assembly 218 is mounted to an upper rear portion of the vehicle 102, such as adjacent to a Center High Mount Stop Lamp (CHMSL). The rear sensor assembly 218 may also include multiple sensors 106, such as a camera and a lidar sensor for monitoring the FoV behind the vehicle 104.

As illustrated in FIG. 2, an obstacle 220 (e.g. a construction cone) within a FoV 222 of one or more sensors 184 of the top sensor assembly 212 may be detected. Additionally, the obstacle 220 may also be within a FoV of sensors 184 of other sensor assemblies. Responsive to detecting the obstacle 220, the ADC 182 may process the sensor data and determine an alternative trajectory associated with an evasive maneuver to allow the vehicle 102 to overcome the obstacle. In certain situations, the ADC 182 may determine the alternative trajectory involves only minimum complexity and automatically perform the evasive maneuver without seeking for any assistance or approval. In other situations, nevertheless, responsive to determining the alternative trajectory is associated with a complexity higher than a predefined threshold or being unable to determine a practical alternative trajectory, the ADC 182 may slow down and stop before the obstacle 220 and requests for remote guidance from the server 178.

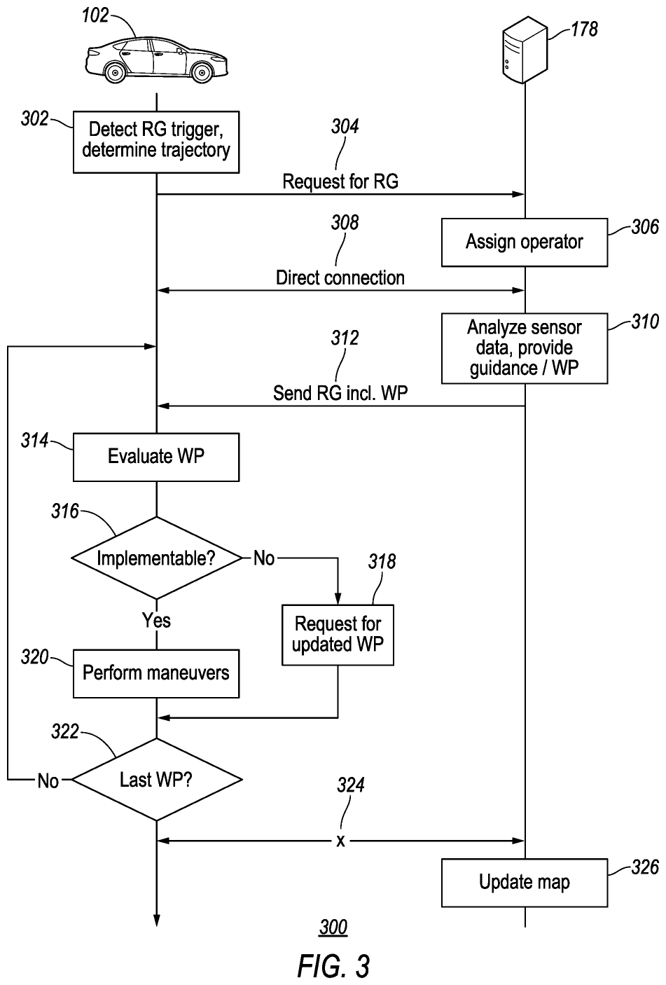

Referring to FIG. 3, an example flow diagram of a process 300 for providing the vehicle remote guidance of one embodiment of the present disclosure is illustrated. With continuing reference to FIGS. 1 and 2, the process 300 may be implemented via the vehicle 102, the server 178 as well as other necessary or optional components shown or not shown. With continuing reference to FIGS. 1 and 2, the process 300 may be implemented via the vehicle 102, the server 178 as well as other necessary or optional components shown or not shown. At operation 302, while operating in the autonomous driving mode, the vehicle 102 detects a trigger event that requires the remote guidance from the server 178. The trigger events may include a variety of predefined scenarios beyond the designed capability for the ADC 182 to handle on its own. As a few non-limiting examples, the trigger events may include a blocked lane, a construction zone, an obstacle on the vehicle route or the like. Additionally or alternatively, the remote guidance request may be manually triggered by a vehicle user via the HMI controls 112.

In response to the trigger event, at operation 304, the vehicle 102 communicates to the server 178 to request for remote guidance by sending a request. The remote guidance request may include various information entries. For instance, the remote guidance request may include type/category of the trigger event as detected via vehicle sensors 184. The remote guidance request may further include information associated with the trigger event such as the current location of the vehicle 102, the weather and temperature data. The remote guidance request may further include data reflecting the current condition of the vehicle such as vehicle make/model, suspension setting (e.g. height), fuel level (e.g. battery state of charge), tire pressure, motor/engine operating condition (e.g. temperature), vehicle occupancy data (e.g. number of occupant, presence of children) or the like that may be used to determine if certain maneuvers are available.

In response to receiving the remote guidance request, at operation 306, the server 178 assigns an operator to help provide remote guidance to the requesting vehicle 102. In one example, the operator may be a human being (e.g. technician). Additionally or alternatively, the operator may be a computer program (e.g. artificial intelligence) configured to analyze and resolve more difficult situations than the ADC 182 is configured to handle. For instance, due to the portable nature, the ADC 182 may be provided with relatively limited processing capability and is unable to perform more advanced processing. In comparison, the server 178 may be provided with better processing power and be able to better analyze the sensor data to provide more autonomous driving instructions without the involvement of a human operator. Additionally or alternatively, the server 178 may be further configured to assign different types of trigger events to different levels of operators. For instance, a simple trigger event may be assigned to the computer program, a mid-level trigger event may be assigned to a junior human operator, and a complex trigger event may be assigned to a senor human operator for handling.

Once the remote guidance request has been assigned, at operation 308, the server 178 and the vehicle 102 establish direct connection such that the server 178 is granted access to the various sensor data currently and previously captured via various vehicle sensors 184. For instance, the server 178 may access sensor data indicative of one or more objects within the near-field and/or far-field FoV in one or more directions from the vehicle 102. Due to the large amount of live data to transmit from the vehicle 102 to the server 178, a fast data connection with large bandwidth may be required. In most cases, the direct connection established via the TCU 170 through the wireless network 172 is sufficient for the remote guidance. However, in cases that the direct connection is insufficient to satisfy the data transaction demand, a secondary connection may be established in addition to the direct connection to supplement the data transaction. For instance, the secondary connection may be established via the mobile device 128 associated with a vehicle occupant and connected to the computing platform 104 via the transceiver 132. In response to receiving a request from the computing platform 104 to establish the secondary connection, the mobile device 128 may connect to the server 178 such that the vehicle 102 communicates with the server 178 via both the direct connection and the secondary connection.

The computing platform 104 may be further configured to split the sensor data into the two connections based on data importance and/or sensor assemblies. For instance, more important data from the top sensor assembly 212, side sensor assemblies 214, and front sensor assemblies 216 may be communicated to the server 178 via the direct connection, while lesser important data from the rear sensor assembly 218 may be communicated to the server 178 via the secondary connection. The vehicle 102 may send a predefine sensor data to the server 178 by default and send other sensor data to the server 178 on the on-demand basis. For instance, once the direction connection is established, the vehicle 102 may send only sensor data from the top sensor assembly 212 and the front sensor assemblies 216 by default via the TCU 170. Responsive to receiving a server demand for sensor data from the side sensor assemblies 214 and the rear sensor assembly 218, the vehicle 102 may supply the corresponding sensor data to the server 178 via the TCU 170 and/or the mobile device 128.

At operation 310, the operator associated with the server 178 analyzes the sensors data and generates input to provide guidance to the vehicle 102. The operator may determine and generate a remote guidance including one or more alternative trajectories as defined by one or more waypoints to allow the vehicle 102 to overcome the trigger event. The remote guidance and alternative trajectories may be generated and provided in various manners. In simpler cases such as an obstacle is blocking the vehicle lane while another lane is detected available for the vehicle 102 to pass, the remote guidance may include a command that permits/approves the vehicle 102 to use the other lane. Alternatively, in more complicated situations such as a construction zone and/or multiple obstacles are detected where no obvious passes are detected, the remote guidance may include the alternative trajectory that is defined and customized by one or more waypoints (a.k.a. breadcrumbs) for the vehicle 102 to follow until the situation is cleared. The waypoints may be generated using the various sensor data by the operator. The present example is directed to the more complicated situation in which waypoints are provided.

In one example, the initial remote guidance may include the entire alternative trajectory and/or a plurality of waypoints defining the entire alternative trajectory before the vehicle 102 enters the alternative trajectory. Alternatively, the initial remote guidance may only include a section of the alternative trajectory or the defining waypoints as the current sensor data is insufficient for the operator the generate the entire alternative trajectory. In this case, the alternative trajectory may be defined and generated in a real-time manner. As the vehicle 102 enters and traverses the available section of the alternative trajectory and the vehicle sensors 184 continue to measure the surroundings of the vehicle 102, more sensor data may become available for the operator to generate subsequent waypoints defining the rest sections of the alternative route.

At operation 312, the server 178 transmits the remote guidance to the vehicle 102. The remote guidance may include various command entries depending on the specific situations. In the present example, the remote guidance may include the entire or a section of the alternative trajectory as discussed above. Additionally or alternatively, the remote guidance may include one or more waypoints defining the entire or a section of the alternative trajectory in addition to or in lieu of the continuous alternative trajectory.

At operation 314, responsive to receiving the remote guidance, the ADC 182 of the vehicle 102 evaluates one or more alternative trajectories or waypoint to determine if the alternative trajectory is implementable. It is noted that although the remote guidance is provided by the server 178, the remote guidance commands are treated more as a recommendation by the ADC 182, rather than mandates. If the ADC 182 determines the alternative trajectory is unavailable or may result in an undesired outcome in a high likelihood (e.g. being too close to an obstacle), the ADC 182 may refuse to implement the remote guidance commands and the process proceeds to operation 318 to report the situation to the operator and request for a new alternative trajectory or waypoints. Additionally, the vehicle may impose requirements on the distance between each of the plurality of waypoints. Responsive to detecting the distance between two adjacent waypoints are beyond the requirement (e.g. too far apart), the ADC 182 may reject the waypoints and request for new waypoints. In cases that only the waypoints are provided, the ADC 182 may be further configured to generate the alternative trajectory (or at least a section) using the waypoints. Various processing such as Bezier smoothing may be performed to generate the alternative trajectory using the waypoints.

If the answer for operation 316 is yes indicative of the alternative trajectory is available, the process proceeds to operation 320 and the ADC 182 operates the vehicle 102 to perform maneuvers corresponding to the alternative trajectory while being monitored by the operator associated with the server 178. As discussed above, the server 178 may continuously send updated trajectories and waypoints in remote guidance while the vehicle 102 traverses the trajectory until the ADC 182 and/or the operator determines the vehicle 102 has successfully overcome the situation by completing the last waypoint. If there are other waypoints that the vehicle 102 is yet to complete, the process returns from operation 322 to operation 312 to continue to the remote guidance process.

Responsive to detecting the vehicle 102 has completed the last waypoints set by the operator, the process proceeds to operation 324 to complete the remote guidance session. The vehicle 102 may terminate the direct connection and disconnect from the server 178.

At operation 326, the server 178 records the trigger event along with the alternative trajectory and waypoints successfully implemented by the vehicle 102 by updating the map. The updated map may be used to facilitate any future remote guidance request from other vehicles. For instance, responsive to receiving a subsequent remote guidance request from another vehicle associated with the same trigger event, the server 178 may be more likely to assign the current request to a computer program and provide the guidance using the successfully implemented trajectory and waypoints.

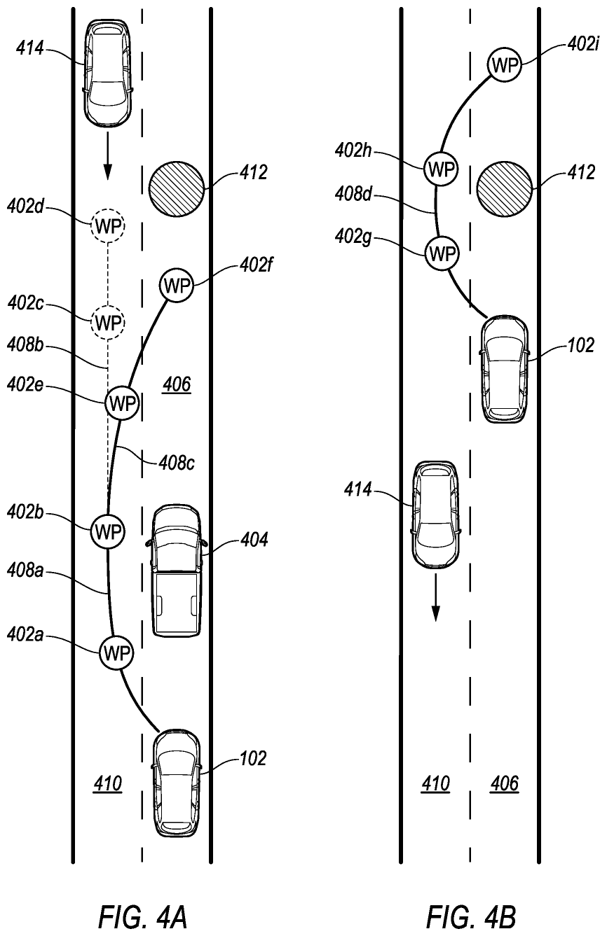

Referring to FIGS. 4A and 4B, an example schematic diagram 400 of the vehicle remote guidance system of one embodiment of the present disclosure is illustrated. With continuing reference to FIG. 1 to 3, the server 178 provides remote guidance including a plurality of waypoints 402 to the requesting vehicle 102 in the present example. Referring to FIG. 4A, responsive to detecting a parked truck 404 blocking a lane 406 on which the vehicle 102 is traversing, the vehicle 102 may start requesting remote guidance from the server 178 while slowing down and stopping behind the truck 404. In response, the server 178 sends the requesting vehicle 102 remote guidance including a plurality of waypoints 402. Additionally, the remote guidance may further include command to instruct the requesting vehicle 102 to stop behind the truck at a predefined distance until a least a section of an alternative trajectory 408 is determined implementable. As illustrated with reference to FIG. 4A, the requesting vehicle 102 may initially receive two waypoint 402a and 402b that defines a first section 408a of the alternative trajectory passing the parked truck 404 using a left lane 410 designed for oncoming traffic. At the time when the first two waypoints 402a and 402b are provided, no oncoming traffic on the left lane 410 is detected and therefore the requesting vehicle 102 may proceed to the first section 408a of the alternative trajectory.

As the requesting vehicle 102 implements driving maneuvers on the alternative trajectory 408, sensor data is continuously provided to the server 178 for generating any subsequent waypoints 402. In the present example, as the requesting vehicle 102 arrives at the first waypoint 402a, two more waypoints 402c and 402d may be received to define a second section 408b of the alternative route that continues on the left lane because the vehicle sensors data indicates an obstacle 412 occupying the right lane 406 is detected ahead. The second section 408b continues from the first section 408a of the alternative route without a gap such that the requesting vehicle 102 continues to drive along the alternative trajectory 408 without needing to slow down or stop.

As the requesting vehicle 102 continues to drive on the alternative trajectory, the vehicle sensor 184 may detect an automobile 414 having the right-of-way on the left lane in the oncoming direction is approaching the requesting vehicle 102. Since the oncoming automobile 414 has the right-of-way, the requesting vehicle 102 needs to yield. In response to the new sensor data indicative of the detection of the oncoming traffic 414, a revised remote guidance including new waypoints 402 may be provided. For instance, the server 178 may provide two more new waypoints 402e and 402f to overwrite the previously provided waypoints 402c and 402d, and therefore the previously determined second section 408b of the alternative trajectory is replaced by a third section 408c. As illustrated in FIG. 4A, the third section 408c of the alternative trajectory continues from the first section 408a and leads the requesting vehicle 102 back to the right lane 406 before being able to pass the obstacle 412. The revised remote guidance may further include commands instructing the requesting vehicle 102 to slow down or stop behind the obstacle 412 until the oncoming traffic 414 is cleared. It is noted that although the new waypoints 402e and 402f have the same number as the replaced waypoints 402c and 402d (e.g. both two waypoints), the present disclosure is not limited thereto. The server 178 may send a different number of waypoints compared with the number of waypoints to be replaced.

Referring to FIG. 4B, a fourth section 408d of the alternative trajectory may be defined by a plurality of subsequent waypoints 402g, 402h and 402i provided to the requesting vehicle 102 by the server 178. The fourth section 408d defines the last part of the alternative trajectory 408 that allows the requesting vehicle 102 to pass the obstacle 412 using the left lane 410 and merge back to the right lane 406 once the upcoming traffic 414 is cleared. The last waypoint 402i may be provided with a special mark indicative of that no more subsequent waypoints will be provided by the server 178. The ADC 182 of the vehicle 102 may be programmed to automatically end remote guidance and switch back to the autonomous driving mode after arriving at the last waypoint 402i. In the present example, the requesting vehicle 102 may continue to drive after passing the last waypoint 402i without stopping. In other examples, the last waypoint 402i may be marked as instructing the requesting vehicle to stop (e.g. at the intersection) upon arrival.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors may be interchanged herein, as may the words controller and controllers.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle, comprising:
a sensor configured to provide sensor data indicative of an environment outside the vehicle;
one or more transceivers configured to communicate with a server; and
one or more controllers configured to,
responsive to the sensor data indicative of a predefined trigger event, send a request for remote guidance to the server via the transceiver,
receive an instruction including a plurality of waypoints from the server,
determine a first section of a trajectory along a route defined by the waypoints, and
perform a driving maneuver to implement the trajectory.

2. The vehicle of claim 1, wherein the one or more controllers are further configured to:
responsive to receiving one or more subsequent waypoints, determine a second section of the trajectory along the route continuing from the first section.

3. The vehicle of claim 1, wherein the one or more controllers are further configured to:
responsive to receiving one or more replacement waypoints, replace one or more of the plurality of waypoints with the one or more replacement waypoints; and
revise the first section of the trajectory using the replacement waypoints.

4. The vehicle of claim 3, wherein the one or more replacement waypoints define an alternate trajectory that is different from the trajectory.

5. The vehicle of claim 1, wherein the one or more controllers are further configured to:
responsive to detecting that the first section of the trajectory is unimplementable, refrain from performing the driving maneuver and request the server for one or more replacement waypoints.

6. The vehicle of claim 1, wherein the one or more controllers are further configured to:
determine the first section of the trajectory by performing a Bezier smoothing based on the plurality of waypoints.

7. The vehicle of claim 1, wherein the one or more controllers are further configured to:
establish a first wireless connection with a mobile device via the one or more transceivers;
send a first sensor data to the server via the first wireless connection through the mobile device; and
send a second sensor data to the server via a second wireless connection without going through the mobile device.

8. The vehicle of claim 1, wherein the instruction further includes a command instructing the vehicle to not stop at a last one of the plurality of waypoints and return to autonomous driving mode.

9. The vehicle of claim 1, wherein the instruction further includes a command instructing the vehicle to stop at one or more of the plurality of waypoints.

10. A method for a vehicle, comprising:
requesting remote guidance in response to detecting a predefined trigger event via a sensor;
receiving an instruction including a first section of a trajectory along a route defined by a plurality of waypoints; and
performing a driving maneuver to traverse the first section of trajectory.

11. The method of claim 10, further comprising:
continuing to perform the driving maneuver to traverse a second section of trajectory in response to receiving the second section of the trajectory defined by one or more subsequent waypoints.

12. The method of claim 11, further comprising:
performing the driving maneuver to traverse a third section of the trajectory and ignoring the one or more subsequent waypoints of the second section in response to receiving a third section of the trajectory defined by one or more replacement waypoints indicative of a replacement to the one or more subsequent waypoints of the second section.

13. The method of claim 11, further comprising:
traversing the trajectory from the first section to the second section without slowing down the vehicle.

14. The method of claim 11, further comprising:
slowing down the vehicle while traversing the first section of the trajectory before entering into the second section.

15. The method of claim 10, further comprising:
detecting that the first section of the trajectory is unimplementable; and
refraining from performing the driving maneuver and requesting a replacement trajectory.

16. A non-transitory computer-readable medium comprising instructions, when executed by a controller of a vehicle, cause the vehicle to perform operations comprising:
responsive to receiving a first instruction including a plurality of waypoints from a server, determine a first trajectory using the waypoints, and
perform a driving maneuver to implement the first trajectory.

17. The non-transitory computer-readable medium of claim 16, further comprising instructions, when executed by a controller of a vehicle, cause the vehicle to perform operations comprising:
responsive to receiving a second instruction including one or more subsequent waypoints, determine a second trajectory continuing from the first trajectory.

18. The non-transitory computer-readable medium of claim 17, further comprising instructions, when executed by a controller of a vehicle, cause the vehicle to perform operations comprising:
responsive to receiving a third instruction including one or more replacement waypoint, replace one or more of the subsequent waypoints; and
revise the second trajectory using the replacement waypoints.

19. The non-transitory computer-readable medium of claim 16, further comprising instructions, when executed by a controller of a vehicle, cause the vehicle to perform operations comprising:
responsive to detecting that a distance between two adjacent waypoints is beyond a threshold distance, refrain from performing the driving maneuver; and
request updated waypoints from the server.

20. The non-transitory computer-readable medium of claim 17, further comprising instructions, when executed by a controller of a vehicle, cause the vehicle to perform operations comprising:
traverse from the first trajectory to the second trajectory without slowing down the vehicle.
